(19) United States
(12) Patent Application Publication
(10) Pub. No.: US 2025/0168759 A1
(43) Pub. Date: May 22, 2025

(54) SERVICE-BASED HOSTING NETWORK DISCOVERY AND SELECTION

(71) Applicant: Lenovo (Singapore) Pte. Limited, Singapore (SG)

(72) Inventors: Genadi Velev, Darmstadt (DE); Apostolis Salkintzis, Athens (GR); Dimitrios Karampatsis, Ruislp (GB)

(73) Assignee: Lenovo (Singapore) Pte. Limited, Singapore (SG)

(21) Appl. No.: 18/843,013

(22) PCT Filed: May 11, 2022
(86) PCT No.: PCT/EP2022/062761

§ 371 Date: Aug. 30, 2024

(30) Foreign Application Priority Data
Mar. 2, 2022 (GR) 20220100192

(51) Int. Cl. H04W 48/18

(52) U.S. Cl. CPC H04W 48/18

(57) ABSTRACT

There is provided a method performed by a user equipment, UE, for allowing the UE to use a localized service in a hosting network, the method comprising: obtaining configuration information, the configuration information containing a list of one or more preferred hosting networks for the localized service; determining one or more available networks; from the determined one or more available networks, identifying one or more hosting networks on the list of the UE, human-readable information, the human-readable information being based on the identified one or more hosting networks; receiving a user input indicative of a user of the UE selecting a hosting network of the identified one or more hosting networks; and establishing a network connection with the selected hosting network.

### FIELD

The subject matter disclosed herein relates generally to the field of policy configuration to select a hosting network. This document defines methods and apparatuses for service-based hosting network discovery and selection.

### BACKGROUND

With the advance of 5th generation (5G) services and network, it may be possible to deploy local 5G networks at various venues which offer one or more local services, connectivity to non-local service providers, and services to public network operators. The local services are hereinafter referred to as localized services. Such localized services are usually provided within certain timeframes and/or at certain geographic locations, and the 5G network acting as hosting network offering access to such localized services may be either a public land mobile network (PLMN) or a non-public network (NPN).

### SUMMARY

A problem with existing policy configurations for selecting hosting networks is that of discovering and selecting a hosting network according to its suitability for accessing and providing localized services.

Disclosed herein are procedures for service-based hosting network discovery and selection. Said procedures may be implemented by a user equipment and one or more network nodes of a home network of the user equipment.

In an aspect, there is provided a method performed by a user equipment, UE, for allowing the UE to use a localized service in a hosting network, the method comprising: receiving, via a first network connection with a serving network, configuration information, the configuration information specifying the serving network and including a traffic routing policy rule comprising a traffic descriptor for identifying traffic of the localized service to be routed via the hosting network; detecting that a traffic flow matches the traffic routing policy rule; responsive to detecting that the traffic flow matches the traffic routing policy rule, selecting the hosting network; and establishing a second network connection with the hosting network.

In a further aspect, there is provided a user equipment, UE, apparatus comprising: a receiver arranged to receive, via a first network connection with a serving network, configuration information, the configuration information specifying the hosting network and including a traffic routing policy rule comprising a traffic descriptor for identifying traffic of the localized service to be routed via the hosting network; and one or more processors arranged to: detect that a traffic flow matches the traffic routing policy rule; responsive to detecting that the traffic flow matches the traffic routing policy rule, select the hosting network; and establish a second network connection with the hosting network.

In a further aspect, there is provided a method performed by one or more network nodes of a serving network of a user equipment, UE, the method comprising: determining that the UE has to be arranged to allow the UE to use a localized service in a hosting network; generating configuration information, the configuration information specifying the hosting network and including a traffic routing policy rule comprising a traffic descriptor for identifying traffic of the localized service to be routed via the hosting network; and sending the generated configuration information to the UE.

In a further aspect, there is provided one or more network nodes of a serving network of a user equipment, UE, the one or more network nodes comprising: one or more processors arranged to: determine that the UE has to be arranged to allow the UE to use a localized service in a hosting network; and generate configuration information, the configuration information specifying the hosting network and including a traffic routing policy rule comprising a traffic descriptor for identifying traffic of the localized service to be routed via the hosting network; and a transmitter arranged to send the generated configuration information to the UE.

In a further aspect, there is provided a method performed by a user equipment, UE, for allowing the UE to use a localized service in a hosting network, the method comprising: obtaining configuration information, the configuration information containing a list of one or more preferred hosting networks for the localized service; determining one or more available networks; from the determined one or more available networks, identifying one or more hosting networks on the list of one or more preferred hosting networks; displaying, on a display of the UE, human-readable information, the human-readable information being based on the identified one or more hosting networks; receiving a user input indicative of a user of the UE selecting a hosting network of the identified one or more hosting networks; and establishing a network connection with the selected hosting network.

In a further aspect, there is provided a user equipment, UE, apparatus comprising: a receiver arranged to obtain configuration information, the configuration information containing a list of one or more preferred hosting networks for the localized service; a memory arranged to store the list of one or more preferred hosting networks; one or more processors arranged to: conduct a scan to determine one or more available hosting networks; identify one or more hosting networks of the one or more available hosting networks as being networks which are on the list of one or more preferred hosting networks; a display arranged to display a human-readable name of the identified one or more hosting networks; and a user interface arranged to receive a user input indicative of a user of the UE selecting a hosting network of the identified one or more hosting networks; wherein the one or more processors are arranged to establish a network connection with the selected hosting network.

In a further aspect, there is provided a method performed by one or more network nodes of a home network of a user equipment, UE, the method comprising: determining that the UE has to be arranged to allow the UE to use a localized service in a hosting network; generating configuration information, the configuration information containing a list of one or more preferred hosting networks for the localized service; and sending the generated configuration information to the UE.

In a further aspect, there is provided one or more network nodes of a home network of a user equipment, UE, the one or more network nodes comprising: one or more processors arranged to: determine that the UE has to be arranged to allow the UE to use a localized service in a hosting network; and generate configuration information, the configuration information containing a list of one or more preferred hosting networks for the localized service; and a transmitter arranged to send the generated configuration information to the UE.

In a further aspect, there is provided a method comprising sending, by an application function, AF, supporting one or more localized services on a hosting network, to a UDM/UDR of a serving network serving a UE, a list of one or more preferred hosting networks for the one or more localized services and, optionally, availability or selection criteria associated with each of the preferred hosting networks in the list of one or more preferred hosting networks. The method may further comprise the UDM/UDR sending the received list of one or more preferred hosting networks (and, optionally, the availability or selection criteria) to a PCF of the serving network. The method may further comprise generating, by the PCF, configuration information (which may include a URSP rule) using the list of one or more preferred hosting networks (and, optionally, the availability or selection criteria). The method may further comprise, the UDM/UDR generating and sending to the UE a list of preferred hosting networks (and, optionally, the availability or selection criteria). The method may further comprise sending, from the serving network to the UE, the generated configuration information.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for service-based hosting network discovery and selection will now be described, by way of example only, with reference to the accompanying drawings, in which:

FIG. 1 is a schematic illustration of a network architecture for connectivity between a user equipment apparatus, a local (hosting) network, a home network, and localized service providers.

FIG. 2 is a schematic illustration of a user equipment apparatus that may be used for implementing the methods described herein.

FIG. 3 is a schematic illustration further details of a network node that may be used for implementing the methods described herein.

FIG. 4 is a schematic illustration of a signaling flow for configuring the user equipment apparatus with information for hosting network selection.

FIG. 5 is a schematic illustration of a traffic routing policy rule for hosting network selection.

FIG. 6 is a schematic illustration of information for hosting network selection configured in the user equipment apparatus.

FIG. 7 is a process flow chart showing certain steps of a method performed by the user equipment apparatus for automatic service-based hosting network discovery and selection, thereby to allow the user equipment apparatus to use one or more localized services in the hosting network.

FIG. 8 is a process flow chart showing certain steps of a method performed by one or more network nodes of the home network of the user equipment apparatus for configuring the user equipment apparatus for automatic service-based hosting network discovery and selection.

FIG. 9 is a process flow chart showing certain steps of a further method performed by the user equipment apparatus for manual service-based hosting network discovery and selection, thereby to allow the user equipment apparatus to use one or more localized services in the hosting network.

FIG. 10 is a process flow chart showing certain steps of a further method performed by one or more network nodes of the home network of the user equipment apparatus for configuring the user equipment apparatus for manual service-based hosting network discovery and selection.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

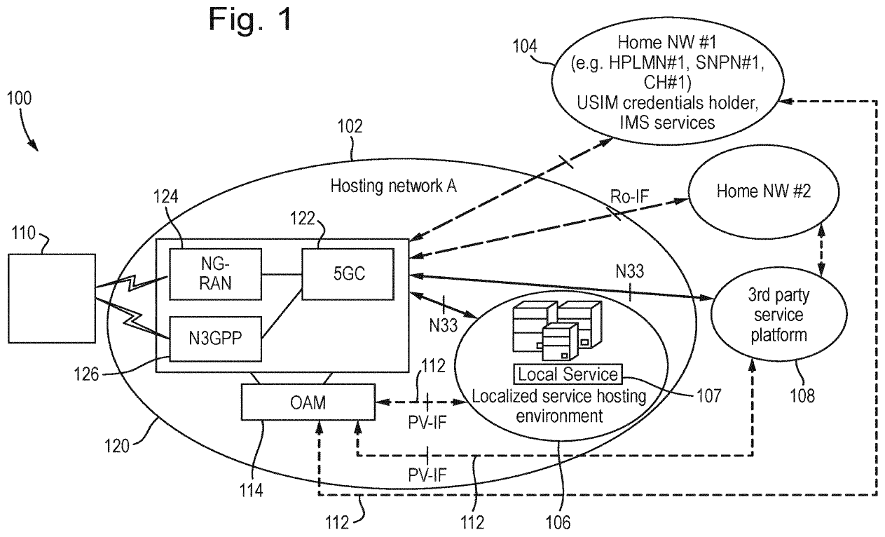

One example of hosting network deployment is shown in FIG. 1.

A problem realized by the present inventors is that of configuring a user equipment (UE) to enable the UE to discover/select a hosting network which may provide localized services, and of accessing the localized services, which may be provided by the hosting network (when first conditions are fulfilled) or a home network (when second conditions are fulfilled).

FIG. 1 depicts a network architecture 100 for connectivity between a user equipment (UE), a local network, a serving network, and localized service providers.

The local network may be considered a hosting network (HtNW) 102. The HtNW 102 may be deployed as a non-public network (e.g. including stand-alone non-public network, SNPN; or public network integrated non-public network, PNI-NPN) or as a public network. The HtNW 102 can offer the following services:
Non-local services, via one or more public networks or Internet access services. In this embodiment of the network architecture 100, the non-local services may be provided via a serving network, which in this embodiment is a home network, e.g. a home public land mobile network (HPLMN), which will hereinafter be referred to as the home NW 104. There may be a service level agreement between the HtNW 102 and the home NW 104 which may offer:
   local break out (LBO) connections which offer default IP access services; and/or
   home-routed connections to the home NW 104 (e.g. for IMS applications or other services provided by the HPLMN).
Localized services, which may be enriched compared to non-local services offered via an Internet connection. In this embodiment of the network architecture 100, the localized services may be provided via a localized service hosting environment 106 which may be referred to as a localized services provider or localized service operator. The end users of the localized services need information/incentive/instruction to seek access to the localized services in a convenient way. In the example of FIG. 1, one or more service of the localized services is used by a local application (App) 107.
Services from third-party service providers. In this embodiment of the network architecture 100, the services from third-party service providers may be provided via a third-party service platform 108. The third-party service platform 108 may be operated by an entity/company different from an entity/company operating the HtNW 102 or the home NW 104. The third-party service providers may offer services to either the HtNW 102 or the home NW 104 (e.g. based on different time or location conditions).

In this embodiment, the home NW 104 is a “home network” from the perspective of a UE 110. The serving network of the UE is the home network of the UE, i.e. the home NW 104. The home network is the network to which the UE 110 has subscribed, and the home network stores the UE's Subscription Permanent Identifier (SUPI) and credentials. In this embodiment, the home network of the network architecture 100 is a public network, e.g. the home NW 104. However, in other embodiments, the home network is a different home network with respect to the UE 110, e.g. a stand-alone non-public network (SNPN) or a credential holder (CH).

In one embodiment of the network architecture 100, the HtNW 102 may be deployed in a stadium or congress center (e.g. a trade fair or concert hall) where the coverage of the HtNW 102 is overlapping with the coverage of the home network, which include the home NW 104. In other embodiments, the HtNW 102 may provide coverage in areas where there is no coverage provided by the home networks. Real-world scenarios in which the HtNW 102 may provide coverage in areas where there is no coverage provided by the home networks include, for example, at fair grounds and other (e.g., temporary) establishments situated far from other infrastructure.

In this embodiment, the HtNW 102 and the localized service hosting environment 106 may be respectively operated by entities different from the respective entities operating the home NW 104 or third-party service platform 108 (e.g., AR/VR application provider, video streaming provider (e.g. Netflix), Gaming application providers, etc.). Furthermore, it is possible that the hosting network 102 is available only within limited time periods and geographical regions. It is further possible that the hosting network 102 is deployed and operates on long term, but the localized services are offered or available only within limited time periods and geographical regions. Therefore the UE 110 may be configured with an appropriate information to select or access the hosting network under the corresponding limited time periods and geographical regions (e.g. called herewith hosting network selection criteria). Nonetheless, the localized services provided via the hosting network 102 may offer a better user experience than services provided via an Internet connection. In this embodiment, the localized services provided via the hosting network 102 may be established as needed, on a short-term basis, without the need for, e.g., long-term business relationships, permanently installed equipment, etc., between the third-party service platform 108 and the rest of the network architecture 100.

In this embodiment, the UE 110 is assumed to be a subscriber to the home NW 104. Either the UE 110, or the App 107, or the end user of the UE 110 and/or the end user of the App 107 needs information/configuration information to select the HtNW 102 and the localized service hosting environment 106, thereby to access the localized services via the HtNW 102.

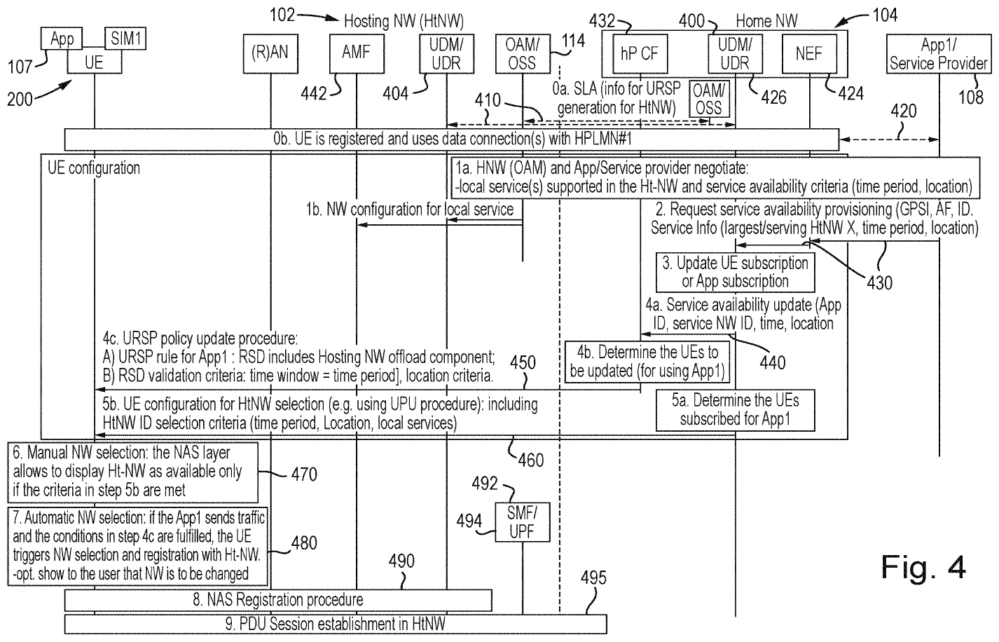

In this embodiment, a provisioning interface (PV-IF) 112 of the hosting network 102 is used to provision or negotiate various localized service requirements, including, e.g., Quality of Service (QoS), expected/maximum number of users, event information for discovery, network slice or data network name (DNN) to be used, required communication protocol (e.g. Internet Protocol (IP)) connectivity, and routing policies, etc. In particular, in this embodiment, the PV-IF 112 is an interface between the localizing service hosting environment 106 and an Operations, Administration and Maintenance (OAM) system 114 of the HtNW 102. Furthermore, the PV-IF 112 is also an interface between the OAM system 114 of the HtNW 102 and the OAM system of the home NW 104. Further details of the PV-IF 112 are provided below in the description of procedure 410, with reference to FIG. 4.

In this embodiment, the HtNW 102 comprises a hosting network architecture 120 including a 5G Core (5GC) network 122, a Next Generation Radio Access Network (NG-RAN) 124, and a non-3GPP (N3GPP) network 126.

In this and other embodiments, the UE 110 may be configured with different types of information, as is explained in more detail with reference to FIGS. 4-7 below.

More specifically, the UE 110 may be configured with one or more UE Route Selection Policy (URSP) rules. The one or more URSP rules are one or more rules for how to route application traffic via a mobile communication network. For example, the one or more URSP rules may be one or more rules for routing application traffic via 3GPP access or via non-3GPP access, and/or via an untrusted or trusted WLAN access. The one or more URSP rules may be one or more rules for routing application traffic non-seamlessly and bypassing the mobile communication network via a WLAN connection. The one or more URSP rules, and one or more procedures for the UE 110 to apply the one or more URSP rules, are described in 3GPP TS 23.502 and 3GPP TS 23.503. The one or more URSP rules contain:
a Traffic Descriptor that allows the UE 110 to determine if a URSP rule of the one or more URSP rules matches application traffic. The Traffic Descriptors may include: one or more Application Descriptors (e.g., OSID/OSAppID); one or more IP flow descriptors (e.g., target addresses of application traffic); one or more DNNs requested by the App 107; or one or more connection capabilities requested by the App 107 (e.g. an IMS connection); and
a Route Selection Descriptor (RSD) that describes to the UE 110 how to route traffic via a Protocol Data Unit (PDU) session. The RSD includes one or more of the following: one or more SSC Mode Selections; one or more Network Slice Selections; one or more DNN Selections; one or more PDU Session Type Selections; one or more Non-Seamless Offload indications; or one or more Access Type preferences.

In this and other embodiments, and as is explained in more detail below with reference to FIGS. 4-7, the UE 110 may route traffic via an existing PDU session that matches the RSD with which the UE 110 is configured. Additionally or alternatively, and as is explained in more detail below with reference to FIGS. 4-7, the UE 110 may initiate the establishment of a new PDU session when the application traffic matches to a URSP rule containing an RSD, for which there is no existing PDU Session, thereby to route traffic via the newly established PDU session.

In an embodiment, the UE 110 may be configured with an “Operator controlled PLMN selector list with Access Types”. The steering, i.e. direction, of the UE 110 (e.g. by the home NW 104) to particular networks, especially in roaming situations, is supported by the network selection procedure specified in 3GPP TS 23.122. In particular, the automatic network selection uses an “Operator controlled PLMN selector with Access Technology” list (a.k.a. a list of preferred PLMN/access technology combinations) which can be stored in a Universal Subscriber Identity (USIM) profile and/or in a mobile equipment (ME), or which can be sent to the UE 110 using steering of roaming (SoR) procedure. The format of the “Operator controlled PLMN selector with Access Technology” list is specified in 3GPP TS 31.102 v17.3.0, in clause 4.2.53, as shown in Table 1.

As can be seen in Table 1, for each PLMN ID there are associated 16 bits (2 bytes), which can be set to indicate one or more radio access technologies which the UE 110 is allowed to use in a corresponding PLMN, e.g. in the home NW 104.

In addition to pre-configured lists of PLMNs in the USIM profile, the home NW 104 may provide SoR information to the UE 110 using the control plane (CP) mechanism specified in 5GS (for UEs in N1 mode of operation). This allows the on-demand update of the list of PLMNs (e.g., an “Operator controlled PLMN selector with Access Technology” list) for network selection.

The present inventors have realized that it is desirable that a network selection procedure considers, i.e. takes into account, when selecting from the list of networks (e.g. PLMNs or SNPNs) for network selection, the specific (localized) service which the UE 110 wants/intends to use.

In order to enable the UE 110 to use localized services, and as is described in more detail below with reference to FIGS. 4-7, the UE 110 is able to discover and/or select and/or access the HtNW 102, thereby to access the localized services.

TABLE 1
“Operator controlled PLMN selector with Access Technology”
list format specified in 3GPP TS 31.102 v17.3.0, 4.2.53.

Identifier: ‘6F61’ Structure: transparent Optional
SFI: ‘11’
File size: 5n bytes, (n ≥ 8) Update activity: low

| Access Conditions: | |
|---|---|
| READ | PIN |
| UPDATE | ADM |
| DEACTIVATE | ADM |
| ACTIVATE | ADM |

| Bytes | Description | M/O | Length |
|---|---|---|---|
| 1 to 3 | 1^{st} PLMN (highest priority) | M | 3 bytes |
| 4 to 5 | 1^{st} PLMN Access Technology | M | 2 bytes |
| | Identifier | | |
| . | . | | |
| . | . | | |
| . | . | | |
| 36 to 38 | 8^{th} PLMN | M | 3 bytes |
| 39 to 40 | 8^{th} PLMN Access Technology | M | 2 bytes |
| | Identifier | | |
| 41 to 43 | 9^{th} PLMN | O | 3 bytes |
| 44 to 45 | 9^{th} PLMN Access Technology | O | 2 bytes |
| | Identifier | | |
| . | . | | |
| . | . | | |
| . | . | | |
| (5n-4) to (5n-2) | N^{th} PLMN (lowest priority) | O | 3 bytes |
| (5n-1) to 5n | N^{th} PLMN Access Technology | O | 2 bytes |
| | Identifier | | |

In particular, a mechanism to discover and/or select and/or access the HtNW 102 thereby to access the localized services may be based on provisioning the UE 110 with “information”. In embodiments described herein, it is proposed that the home NW 104 provides “configuration information” to the UE 110. In these embodiments, the home NW 104 is a network which stores and
manages subscription data associated with the UE 110.

In these embodiments, it is assumed that the UE 110 wishes to use localized services. In one example, the UE 110 may have established a relationship with the localized service provider, i.e. third-party service platform 108 (or service operators) offering the localized services or applications, including the App 107. In another example, the UE 110 may not have relationship with the localized service provider, i.e. third-party service platform 108, before accessing the HtNW 102, and the localized service can be offered to the UE 110 after accessing the HtNW 102.

In these embodiments, and as is described in more detail below with reference to FIGS. 4-7, a set of hosting network selection criteria may be used to discover and/or select and/or access the HtNW 102 (e.g. a local hosting NPN), i.e. a set of selection criteria compared to existing selection criteria for selecting, e.g., PLMNs/SNPNs. The set of hosting network selection criteria may include, for example: a time period (i.e. a start time value and end time value, in units of minutes/hours/days/weeks/months); data location information which may include a current registered network (e.g. PLMN) location, e.g. a tracking area identifier (TAI) associated with the home NW 104 or cell-ID based on a list of services supported in the potential target network, e.g. HtNW 102.

The home NW 104 (or other home network, e.g. a CH) provides the UE 110 with configuration information to use one or more localized services via the HtNW 102 or via the home NW 104 (or other home network) depending on conditions (time period and/or location). The configuration information may include, for example: the one or more URSP rules with a new or updated RSD; and/or information for hosting network selection, which may contain a list of preferred hosting networks associated with the set of hosting network selection criteria.

The home NW 104 (or other home network) generates, e.g. by a home Policy Control Function (H-PCF), and sends to the UE 110 the one or more URSP rules to route the traffic of the one or more localized services (e.g. traffic identified by one or more application IDs, or by one or more traffic characteristics) to a specific HtNW 102.

The RSD may include at least one new RSD component indicating that the traffic is to be sent or routed over a hosting network, wherein the name of such component can be NPN offload indicator or hosting network offload indicator. Alternatively or additionally, the RSD may include a hosting network ID. In this way the home network authorizes and/or controls the UE to perform a network selection to a hosting network (or NPN) by including the new RSD component, e.g. an NPN offload indicator or hosting network offload indicator or hosting network ID, in the URSP rule. The trigger event for network selection towards a hosting network is the detection that an application wants to send localized services traffic which matches to such a URSP rule.

The home NW 104 (or other home network) creates and sends, e.g. by a steering of roaming application function (SoR-AF), a Unified Data Management (UDM) system, an Access and Mobility Management Function (AMF) system, or another network function (NF), to the UE 110 the information for hosting network selection. The information for hosting network selection may include one or more hosting network IDs and/or preferred access types associated with the set of selection criteria. The UE 110 considers the HtNW 102 to be available if there is coverage and if the selection criteria are fulfilled. The UE 110 may then select the HtNW 102, by either manual or automatic selection. Thus, a system and method for re-mapping the traffic for localized services is provided, whereby the UE 110 moves from a source network (e.g. comprising access network and core network) to a target network (e.g. comprising access network and core network). This system and method are described in more detail below with reference to FIGS. 4-7.

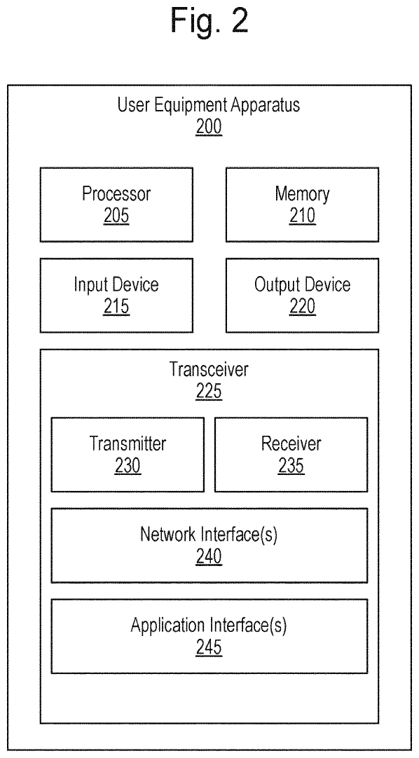

FIG. 2 depicts a user equipment apparatus 200 that may be used for implementing the methods described herein. The user equipment apparatus 200 is in accordance with the UE 110 described above. The user equipment apparatus 200 is used to implement one or more of the solutions described below. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the UE behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implementing a traffic category field. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink (UL) communication signals to a base unit of a wireless communications network. Similarly, the one or more receivers 235 may be used to receive downlink (DL) communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

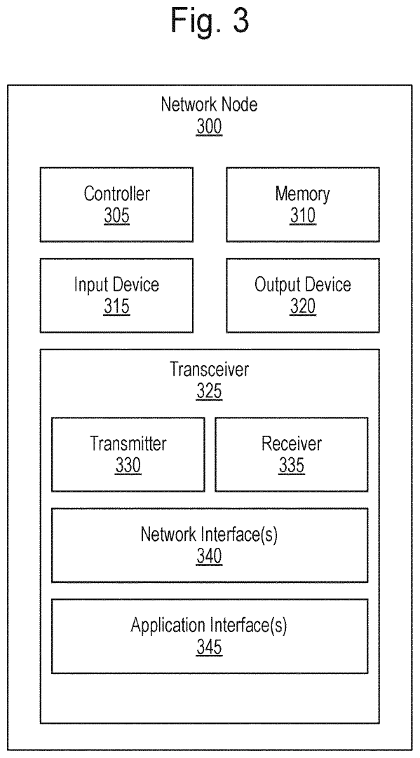

FIG. 3 depicts a network node 300 that may be used for implementing the methods described herein. The network node 300 may be one implementation of an entity in a wireless communications network, e.g. the HtNW 102 and/or the home NW 104 and/or, unless stated otherwise, any of the other networks described herein. The network node 300 may be, for example, the UE 200 described above. The network node 300 includes a controller 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a GPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described below. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

FIG. 4 is a schematic illustration of a signaling flow for configuring the UE 200 with information for hosting network selection.

In this embodiment, the HtNW 102 and home NW 104 may have first established a relationship and/or a service level agreement to allow subscribers to home NW 104 to register and use services in the HtNW 102. Specifically, in this embodiment, a first OAM or operating and operations support system (OSS) or first UDM system 400 of the home NW 104 establishes the relationship and/or service level agreement with a second OAM or OSS system 402 of HtNW 102 and/or with a second UDM system 404 of the HtNW 102. This relationship and/or service level agreement is indicated in FIG. 4 with double-headed arrows and the reference numeral 410.

Negotiation may be performed between business support interfaces of a business support system (BSS) of the network architecture 100. The BSS may, for example, propagate a corresponding service-related or network slice-related configuration via respective OAM systems in each of the networks.

In this embodiment, the HtNW 102 and the home NW 104 may negotiate: which of the one or more localized services may use local break-out (LBO) such that the PDU session for one or more localized services can be terminated in the HtNW 102 and the traffic may access the localized services provider or the Internet from the HtNW 102; and which non-localized services should be home-routed, for which home-routed PDU session should be established and terminated in the home NW 104.

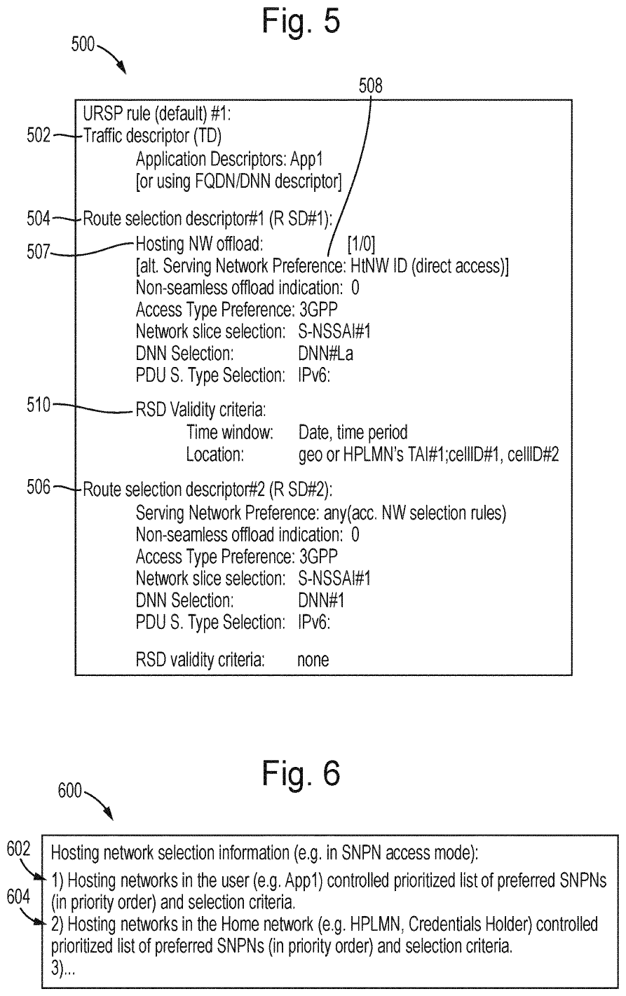

In addition, the HtNW 102 may inform the home NW 104 about the desired one or more URSP rules applicable in the HtNW 102. For example, the HtNW 102 may prefer that traffic to the App 107 is routed to a local DNN (e.g. DNN #La), as shown in FIG. 5.

The HtNW 102 and the home NW 104 may negotiate how the UE 200 connected to the home NW 104 is authenticated and authorized (e.g. by network primary authentication and authorization) in the HtNW 102 during the registration procedure with the HtNW 102. By way of example, an N32 interface between the HtNW 102 and home NW 104 may be set up as outlined in 3GPP TS 23.501, clause 5.30.2.9.3.

In this embodiment, the UE 200 may also be registered with the home NW 104 or any other roaming partner of the home NW 104. The UE 200 may also be registered to use data services. For example, the UE 200 may also have set up a service for the App 107, deployed at the third-party service platform 108. This registration and data connection of the UE 200 with the home NW 104 or roaming partner thereof, and/or with the third-party service provider 108, is indicated in FIG. 4 with a double-headed arrow and the reference numeral 420.

In this embodiment, the third-party service provider 108 and the HtNW 102 may also have a service relationship. Specifically, the HtNW 102 (e.g., via the OAM system 114) and the App 107 and/or the third-party service provider 108 may negotiate that a certain service (e.g. the App 107) may be deployed locally in the HtNW 102. The App 107 may be deployed in one or more hosting networks associated with different conditions. For example, a first one or more IDs of the App 107 and/or other third-party services supported in a first hosting network may be associated with a first set of service availability criteria (including, e.g., a first time period, and/or a first location). A second one or more IDs of the App 107 and/or other third-party services supported in a second hosting network may be associated with a second set of service availability criteria (including, e.g., a second time period, and/or a second location).

In particular, the OAM system 114 of the HtNW 102 may configure corresponding network functions (e.g. the second UDM system 404 and/or an AMF 422 in the HtNW 102) with the deployed one or more localized services for the App 107.

In this embodiment, an application function (AF), which may be part of the home network owned or the third-party service provider of App 107, may have a service relationship and/or subscription to use services exposed by the home NW 104. The AF sends a request to the home NW 104 for provisioning of the one or more localized services related parameters, comprising at least one of the following parameters: an AF ID, a list of one or more Generic Public Subscription Identifiers (GPSIs to which the service related parameters apply), a service or application ID (which identifies the localized service or an application using the localized service), a network ID in which the localized service is supported locally (e.g. a list of one or more HtNW IDs), or an availability time period and/or an availability location (i.e. service availability information). The AF sending a request to the home NW 104 to provide the one or more localized services is indicated in FIG. 4 with single-headed arrows and the reference numeral 430.

The service availability information may contain one or more of the following: a time period comprising a start time value and an end time value, a date (e.g. day/week/month/year), or similar description; and a location comprising a geographical area to be serviced (e.g. a geographical location identified by a civic address or shapes). A network exposure function (NEF) 424 or other entity in the home NW 104 may translate the geographical area to a first topological location in the home NW 104 (e.g. a HPLMN ID, one or more TAIs/cell-IDs) or a second topological location in the target HtNW 102 (e.g. a HtNW ID, one or more TAIs/cell-IDs).

The AF may use an existing exposed services, e.g. service-specific parameter provisioning or application guidance for URSP rules determination. The NEF 424 and/or the first UDM system 400 may authorize the request from the AF, i.e. confirm that the AF is trusted or authorized to send a request to provide the one or more localized services, i.e. to initiate a create or update request.

The first UDM system 400 may associate the received information with one or more specific UEs (e.g. the UE 200), which one or more UEs may be identified by, e.g., the list of one or more GPSIs or a group ID. In such a case, the received information may be stored in UE specific subscription data in the first UDM system 400. Additionally or alternatively, the first UDM system 400 may associate the received information with an application ID of the App 107. In such a case, the first UDM system 400 stores the received information in application related subscription information.

The service availability information described above is provided, e.g. via the NEF 424, to a first Unified Data Repository (UDR) 426 of the home NW 104. The first UDR 426 may store the service availability information in related service subscription data and/or in subscription data of the one or more UEs (e.g. UE 200) identified by, e.g., the list of one or more GPSIs. The network, e.g. by the UDM 400, translates each GPSI of the list of one or more GPSIs to a subscriber identity (SUPI). The network, e.g. by the UDM 400, also translates the location of the service availability information to HPLMN topological location information in the home NW 104. Provision of the service availability information by the AF, e.g. via the NEF 424, to the first UDR 426 of the home NW 104 is also indicated in FIG. 4 with single-headed arrows and the reference numeral 430.

In this embodiment, the first UDR 426 may determine to trigger a service availability update procedure based on, i.e. responsive to, different triggers. In one example, the service availability update from the AF described above may constitute such a trigger for the service availability update procedure. In another example, additionally or alternatively, an exchange similar to that of the relationship and/or service level agreement indicated in FIG. 4 with double-headed arrows and the reference numeral 410 may also be used to send the service availability information from the HtNW 102 to the home NW 104. Such an exchange may trigger the first UDR 426 to update the stored service availability information and, as is described in more detail below, trigger a determination that the one or more UEs (e.g. the UE 200) have to be updated for the routing of traffic of the one or more localized services of App 107. The first UDR 426 may update or (re-)configure the service description in a policy control system, specifically in the Policy Control Functions (PCFs). The first UDR 426 may send an application ID, a service network ID where the service may be locally available, and/or service availability information as described above with reference to FIG. 4 and reference numeral 430. The service availability update procedure is indicated in FIG. 4 with a single-headed arrow and the reference numeral 440.

In this embodiment, a home network PCF (H-PCF) 442 of the home NW 104 determines that the one or more UEs (e.g. the UE 200) have to be updated for the routing of traffic of the one or more localized services of the App 107App. A trigger event in the H-PCF 442 may be, e.g., a result of configuration of the relationship and/or service level agreement 410 described above, or the service availability update procedure 440 described above, or a combination thereof. The H-PCF 442 may generate one or more URSP rules described in more detail below with respect to FIG. 5. As is described in more detail below, the one or more URSP rules are enhanced with, or accompanied by, a new RSD component (e.g., a serving network preference or target network) which indicates a network ID to be used for the App 107 and, optionally, access information for the network ID. The access information may include, e.g., whether the target hosting network is to be accessed via 3GPP access or non-3GPP access. In the case of non-3GPP access, the access information may further include whether the non-3GPP access is to use trusted or untrusted access and/or whether, in the case that the non-3GPP is to use untrusted access, a direct or indirect access to a N3IWF is used. Further details about this “serving network preference” information component of the access information are described below with reference to FIG. 5.

In this embodiment, the H-PCF 442 initiates a signaling procedure to update the one or more URSP rules in the UE 200. The update by the H-PCF 442 may include at least one of:
A new URSP rule containing a traffic descriptor (TD) for the traffic of the one or more localized services of App 107App and further containing one or more RSDs including a hosting NW offload component. The hosting NW offload component may contain a single, e.g. binary, indication (e.g., ‘set’ or ‘unset’) or a hosting network ID. Further details of the hosting NW offload component are described below with reference to FIG. 5.
One or more RSD validation criteria comprising a time window, i.e. a time period, and/or a location. The time period may include a start time and an end time, and the format may be, e.g., time of day and date. The location may include a TAI ID or a cell ID associated with a target hosting, i.e. serving, network (e.g. the HtNW 102), or alternatively associated with the home NW 104.
   The signaling procedure to update the one or more URSP rules in the UE 200 is indicated in FIG. 4 with a single-headed arrow and the reference numeral 450.

As is described in further detail below, the configuration of the UE 200 described above in paragraphs [0085]-[0087] may subsequently be used for automatic network selection.

In this embodiment, the home NW 104 (e.g. by the first UDM 400, or the first UDR 426, or an AF responsible for steering of roaming, e.g. a SOR-AF, or a combination thereof) may determine that: the UE 200 is subscribed for, or uses, the App 107; and the UE 200 needs to be provided with information for hosting network selection, i.e. information to allow the UE 200 to select the HtNW 102 for connection. The information for hosting network selection may include a list of network IDs, i.e. one or more hosting network IDs, wherein each of the one or more hosting network IDs may be associated with a respective one or more selection criteria. Each of the one or more selection criteria may, for example, include one or more of: a time period (start time and end time), a location, or one or more supported services of the one or more localized services. The one or more supported services of the one or more localized services may be indicated by one or more service IDs or one or more application IDs which are offered in the respective hosting networks (e.g. in the HtNW 102).

In particular, there are several alternative possibilities for formatting and providing the information for hosting network selection to the UE 200.

Usually, the information for hosting network selection is based on an “Operator controlled PLMN/SNPN selector with Access Technology” list. In this case, the existing “Operator controlled PLMN/SNPN selector with Access Technology” list may be enhanced to include the one or more selection criteria for at least one hosting network (e.g. the HtNW 102), whereas the availability conditions may include the validity time span and/or location.

Alternatively or additionally, SoR information may be used to steer the UE 200 to another hosting network(s). The existing SoR information may be enhanced to include the one or more selection criteria for at least one such hosting network, whereas the availability conditions may include the validity time span and/or location.

Alternatively or additionally, new configuration information, e.g. an “Operator controlled Hosting Network selector with Access technology” list which may also include the one or more selection criteria for at least one hosting network, may be specified.

In addition, if manual hosting network selection is to be allowed (as described in more detail below), the information for hosting network selection may also include information as to how each hosting network ID maps to a human-readable name.

One example of information for hosting network selection is shown in FIG. 6, and described in more detail below.

In this embodiment, the home NW 104 (e.g. by the first UDM 400) may trigger (re-)configuration of the UE 200 for hosting network selection. This (re-)configuration of the UE 200 is indicated in FIG. 4 with a single-headed arrow and the reference numeral 460.

In one example of the configuration of the UE 200 for hosting network selection, the home NW 104 may provide to the UE 200 the information for hosting network selection using the control plane (CP) mechanism specified in 5GS (for UEs in an N1 mode of operation). This allows on-demand update of the UE 200. One such example is described in 3GPP TS 23.122, Annex C.

For example, the first UDM 400 may use a UE parameter update (UPU) procedure to send to the UE 200 the information for hosting network selection.

In one alternative, the UE 200 may use the information for hosting network selection for manual network selection, as is described in more detail below with reference to FIG. 6.

In this embodiment, a manual network selection procedure 470 may be carried out by the UE 200, wherein a user of the UE 200 may request that the UE 200 show available networks. It is conventional that the UE 200 displays currently available networks (and corresponding supported access technologies) to the user or to the application layer, e.g. via a display of the output device 220 of the UE 200. The UE 200 displays human-readable names corresponding to the available networks. In some embodiments, however, the user of the UE 200 may request the manual network selection for hosting networks, i.e. networks offering connectivity to the one or more localized services. For example, the user of the UE 200 may select a localized service to use and by inserting or inputting the selection, the UE 200 triggers the selection of the associated hosting network In embodiments, the UE 200 displays human-readable names of only those hosting network IDs of the one or more hosting network IDs which are physically available (i.e. hosting network IDs of networks within whose coverage the UE 200 is located, meaning that the UE 200 can receive cell broadcast signal from the hosting network) and whose associated one or more selection criteria are fulfilled. Alternatively, the UE 200 may also display a human-readable localized service name instead of or in addition to the human-readable hosting network name, whereas the human-readable localized service name is associated with a hosting network. The association between the localized service and the hosting network may be configured and stored in the UE 200 or may be acquired by the UE 200 in any means.

Hence, for this purpose, the UE 200 should also be configured with information as to how each hosting network ID maps to a human-readable network name or human-readable localized service name, as described above. For the manual selection of hosting network, and corresponding network access, the UE may use subscriber identity and credentials different from the subscriber identity and credentials used to access the home network. In such a case, the information for hosting network selection may be considered as user controlled or operator controlled list of preferred PLMN/access technology combinations, whereas the list of preferred networks may be associated with a localized application and/or selection criteria as described in detailed in other places of this invention. If the information for hosting network selection is provided by the UE's application layer or user interface to the UE, then the information may be considered as user controlled list of preferred PLMN/access technology combinations. If the information for hosting network selection is stored together with the UE identity and credentials for hosting network access (e.g. pre-configured or provisioned in the UE to access the HtNW 102), then information may be considered as operator controlled list of preferred PLMN/access technology combinations. The information for hosting network selection may contain an association between a network ID (e.g. the network ID broadcasted by the available network cells) and the human-readable network name or the human-readable localized service name. Such information may be pre-configured in the UE (e.g. together with the subscriber ID and credentials for hosting network access) or may be provisioned in the UE (e.g. by using steering of roaming procedure).

When the user (or the App 107) triggers the manual hosting network selection procedure 470, the UE 200 first scans for broadcasted signals from hosting networks, and such networks are considered “discovered” networks. Optionally, the user may input the localized service/application (e.g. the App 107 or one or more localized services) in respect of which the hosting network is to be discovered. The user may be presented with a list of localized services/applications from which to select. The discovered networks are then processed or filtered according to the hosting networks stored/listed in the information for hosting network selection or based on the input of desired localized service/application, to which the one or more selection criteria are compared. Only those discovered hosting networks which also fulfil the one or more selection criteria and/or the user input of desired localized services/applications are shown as available hosting networks to the user. It is alternatively or additionally possible that each displayed/shown available hosting network is associated with a localized service/application which has a human-readable name which may be as stored in the one or more selection criteria.

In this embodiment, an automatic network selection procedure 480 may be carried out by the UE 200, after the UE 200 has identified, according to the one or more URSP rules, that the App 107 wants to send traffic (as indicated by reference numeral 450), the UE 200 determines that hosting network offload is to be applied. In other words, the trigger event for hosting network selection is the detection in the UE that the App 107 wants to send traffic to a localized services provider, which may be further characterized as automatic hosting network selection triggered by URSP rules from the Home NW 104. The UE 200 (e.g. in an idle state) starts the automatic hosting network selection procedure 480, i.e. starts to scan for available networks and apply the automatic hosting network selection procedure 480. It is conventional that the UE 200 scans for available networks periodically (e.g. in roaming scenarios) or based on reduced signal strength (e.g. loss-of-coverage scenarios) of a currently registered network. In embodiments, however, the automatic network selection procedure 480 is triggered from the idle state of the UE 200. In these embodiments, the automatic network selection procedure 480 is triggered from the idle state. It is proposed that the UE 200 triggers the automatic network selection procedure 480 to discover/select the HtNW 102 when:
the App 107 wants to send traffic and a matching URSP rule contains a first RSD including a hosting NW offload component is set to a value (e.g. according to the first RSD in FIG. 5) indicative of a requirement that the App 107 (or the matching service) use a data connection (e.g. a PDU session) established in the HtNW 102. In addition, validity criteria of the first RSD should be fulfilled; or
the App already uses a PDU session established in the home NW 104 (e.g. according to the second RSD in FIG. 5) and the validity criteria for the first RSD are fulfilled, which triggers priority of the first RSD over the second RSD. Thus, the UE 200 determines to establish a new PDU session according to the first RSD.
   In either of the above alternatives, the presence of the hosting NW offload component in the first RSD triggers the UE 200 to initiate the automatic hosting network selection procedure 480. For the automatic hosting network selection procedure 480, the UE 200 either: uses the HtNW ID from the first RSD (if applicable—see “[alt. Serving Network Preference: HtNW ID (direct access)]” in FIG. 5); or applies the information for hosting network selection (if available, according to the signaling procedure to update the one or more URSP rules in the UE 200 as described above with reference to FIG. 4 and reference numeral 450).

For example, in this embodiment, when the UE 200 is registered with the home NW 104 and the App 107 wants or intends to send traffic, the UE 200 first inspects a first URSP rule of the matching one or more URSP rules, as shown in FIG. 5. If the first URSP rule contains a valid first RSD (according to the validity conditions) and contains the hosting NW offload component activated (e.g., equal to “1”), the UE 200 triggers the automatic network selection procedure 480 to discover the available hosting networks, according to the information for hosting network selection described above and described in more detail below with reference to FIG. 6. As described previously, the UE 200 uses the information for hosting network selection configured in the UE. The information for hosting network selection can be either independent information configured in the UE 200 (e.g. as per FIG. 4) or information sent within the URSP rule, e.g. a list of preferred hosting networks included in the RSD validity criteria.

In this embodiment, if none of the hosting networks defined by the list of network IDs, e.g. comprising one or more hosting network IDs, (e.g. hosting networks which contain the App 107 as per FIG. 6) are available, the UE 200 applies the second RSD.

In this embodiment, after the UE 200 has selected the HtNW 102, the UE 200 initiates a registration procedure 490 in respect of the HtNW 102. Specifically, the UE 200 sends a registration request which may include requested Network Slice Selection Assistance Information (NSSAI) containing at least Single-Network Slice Selection Assistance Information (S-NSSAI) which matches either the first RSD or the second RSD from the matching URSP which triggered the automatic hosting network selection procedure 480, e.g. a first S-NSSAI from the first RSD, as shown in FIG. 5.

In this embodiment, the HtNW 102 provides the UE 102 with allowed NSSAI, configured NSSAI and/or rejected NSSAI. Preferably the first S-NSSAI is included in the allowed NSSAI. It may be further considered that the HtNW 102 may provide the UE with a set of URSP rules applicable in this HtNW 102. In such a case, the set of URSP rules applicable in this HtNW 102 comprises at least one URSP rule which matches to the traffic of the App 107, wherein the RSD of this rule steers a PDU session to be established to an S-NSSAI and DNN used locally in the HtNW 102.

After a successful registration procedure 490, the UE 200 may trigger the establishment of a PDU session in the HtNW 102 by using the first RSD or second RSD of the first URSP rule matching the App 107. For example, the UE 200 uses the first RSD (shown in FIG. 5) to set up the PDU session. The AMF 422 selects a Session Management Function (SMF) 492 to serve the requested PDU session. The SMF 492 selects and configures a User Plane Function (UPF) 494 for the PDU session. Advantageously, the so-established PDU session tends to offer a better user experience than a corresponding PDU session over the home NW 104 because exemplary a lower delay for the traffic can be assured. Alternatively, the localized service may be only accessed via the HtNW 102 when the RSD validity criteria (or network selection criteria), if available, are fulfilled. Establishment of the PDU session in the HtNW 102 is indicated in FIG. 4 by the reference numeral 495.

Optionally, after successful registration of the UE 200 with the HtNW 102, the UE 200 may show to the user a notification that a network (re-)selection has occurred. This notification is to inform the user that the UE 200 is now using another network. For example, such a notification may appear in the notification bar on the display of the output device 220 of the UE 200, where the network ID of the current serving network, i.e. the HtNW 102, is shown in readable form.

In this embodiment, the manual network selection procedure 470 and the automatic network selection procedure 480 may apply when the UE 200 is in (EMM/RRC) the idle state. For example, if the UE 200 is in the idle state and the App 107 wants to send traffic of the one or more localized services, and there is a matching URSP rule in which the first RSD is valid (according to the RSD validity criteria), then the UE 200 triggers the automatic hosting network selection procedure 480. Alternatively, the user may trigger the manual hosting network selection procedure 470. If, however, the UE 200 is in a connected state when the App 107 wants to send traffic of the one or more localized services, the UE 200 may first transfer to the idle state, e.g. autonomously transfer to the (e.g., Radio Resource Control (RRC)) idle state or request the release of the (e.g., RRC) connection. After transferring to the idle state, the UE 200 may start the network selection procedure for the HtNW 102, either by the manual hosting network selection procedure 470 and the automatic hosting network selection procedure 480.

Thus, the UE 200 may be configured (e.g. with the one or more URSP rules and/or with the information for hosting network selection) to perform network selection for the HtNW 102 when the UE 200 wants to use localized services (e.g. the App 107). The UE 200 is able to apply automatic or manual hosting network selection.

FIG. 5 is a schematic illustration of the first URSP rule 500.

In particular, FIG. 5 shows further details as to how the first URSP rule 500 may be configured for the purposes of this embodiment. The first URSP rule 500 contains: the TD 502, which identifies the application (i.e. the App 107) or traffic type to which the URSP rule applies; and the first and second RSDs 504, 506. The first RSD 504 is enhanced with one or more components which indicate that a hosting network (or a preferred hosting network) is to be used for the matched TD (i.e. for the App 107). In this embodiment, the one or more components may contain one of the following:
The hosting network offload component 507 (e.g. “Hosting NW offload” in FIG. 5) indicating that the application/traffic matching the TD should be routed via the HtNW 102. For example, the value of the hosting network offload component 507 may be “activated” or “deactivated” (or alternatively “set”/“unset”, or alternatively or equivalently “1” or “0”), which identifies whether or not the offload via the HtNW 102 should be initiated. If the value is “activated” then the UE 200 applies the information for hosting network selection as described in FIG. 6. This type of RSD component may be beneficial when there are multiple hosting networks (e.g. SNPNs) available to serve the one or more localized services (e.g. those of the App 107).
A target network ID 508 (i.e. a serving network preference comprising the HtNW ID) which should be selected when the App 107 application wants to send traffic. The serving network preference contains a network ID (e.g. the HtNW ID) different from the home network ID (e.g. that of the home NW 104). The first RSD 504 may also contain an Access Type Preference (e.g. 3GPP) which targets which access type to be used when selecting the network ID from the serving network preference. This type of RSD component may be beneficial when there is a single hosting network (e.g. SNPN) available to serve the one or more localized services.

The first RSD 504 applies, i.e. is valid, if the validity criteria 510 for the first RSD 504 are fulfilled/met, i.e. according to the validity criteria of the first RSD 504. If the validity criteria for the first RSD 504 are not met, the second RSD 506 applies. The second RSD 506 does not contain the hosting network offload component (e.g. “the Hosting NW offload”), or, if it contained, its value is “deactivated”. In some embodiments, the second RSD 506 does not contain the “serving network preference”, and/or does not contain a list of hosting network IDs.

FIG. 6 is a schematic illustration of the information for hosting network selection 600 configured in the UE 200 (e.g. SNPN selection).

In particular, the exemplary information for hosting network selection 600 may be configured in the UE 200. The information for hosting network selection 600 may be created in one or more of the following ways.

In this embodiment, the user or the application layer of the App 107 may generate its own list of preferred hosting networks, as shown in FIG. 6 by the reference numeral 602. For example, the App 107 may receive from an application server on an application layer the list of preferred hosting networks (as described above), and associated list of network IDs, to be used for the one or more localized services of the App 107.

Alternatively or additionally, the information for hosting network selection may be sent from the home NW 104 as indicated in FIG. 4 with a single-headed arrow and the reference numeral 460. This is shown in the FIG. 6 by the reference numeral 604.

In other embodiments, and as is described above, the list of preferred hosting networks may be pre-configured in the UE 200.

FIG. 6 further shows that, as described above, each of the one or more hosting network IDs may be associated with a respective one or more selection criteria. Each one or more selection criteria comprise at least one of the following: a time period (having a start time and an end time), formatted, e.g., as a time of day and date; location information; supported localized services. The one or more selection criteria may comprise a list of one or more service/application IDs. The list of one or more service/application IDs identifies those localized services/applications of the one or more localized services which are supported in the hosting network. In addition, as described above, for manual hosting network selection, a human-readable name may be associated with each service/application ID of the list of one or more service/application IDs.

The information for hosting network selection may be used as a stand-alone configuration, i.e. without the URSP triggered network selection procedure. For example, in the case of manual hosting network selection 470, the information for hosting network selection may be applied by user or application-initiated network selection.

In a further embodiment, mobility and session continuity of a single radio UE 200 is considered as it moves from the home network (i.e., the home NW 104) to the hosting network (i.e., the HtNW 102). The following may apply:

In this embodiment, the UE 200 is registered with the home NW 104, it is in the idle state and camping on a cell of the home NW 104. The UE 200 may have established one or more PDU sessions in the home NW 104.

If the UE 200 is in the connected state, the UE 200 locally transfers to the idle state.

When the App 107 wants to send traffic, the one or more URSP rules, e.g. the first URSP rule, trigger the UE 200 to perform network reselection towards the HtNW 102.

The UE 200 discovers (if available) and selects the HtNW 102. The UE 200 starts a registration, e.g. the registration procedure 490, with the HtNW 102.

After the successful registration in the HtNW 102, the UE 200 may establish one or more home-routed PDU sessions for the previously established one or more PDU sessions, and use the home services in the home NW 104. In addition, the UE 200 may establish one or more PDU sessions in the HtNW 102 for the localized services of the App 107.

If the UE 200 is in the connected state, there will be a service interruption for some short time (e.g., 1 second) which is needed for the UE 200 to select and register with the HtNW 102 and (re-)establish PDU sessions for the one or more localized services already in use.

In another embodiment in which the UE 200 is a dual radio UE, the UE 200 may use one radio chain operating in the PLMN selection mode described above (i.e. to connect to the home NW 104) and use the other radio chain operating in the SNPN access mode described above (i.e. to connect to the HtNW 102 being a SNPN). In such a scenario, the UE 200 may simultaneously register with the home NW 104 and the HtNW 102 as follows.

The UE 200 is registered with the home NW 104 and may use the one or more PDU sessions to establish or to continue to use the one or more localized services offered in the home NW 104.

The UE 200 also selects and registers with the HtNW 102 (e.g. being a SNPN) and the UE 200 uses the one or more localized services (i.e., those of the App 107) in the HtNW 102.

It may be assumed that the UE 200 is not required to pay additional fees when registered and using the HtNW 102. Fees paid to the home NW 104 (with which the UE 200 is subscribed) or paid to the third-party service provider would involve and cover the usage of the HtNW 102. At least, this may be the case when the UE 200 is registered with the HtNW 102 and uses the PDU sessions when the hosting network selection conditions apply (e.g. time period and/or location from the validity criteria of the first RSD 504).

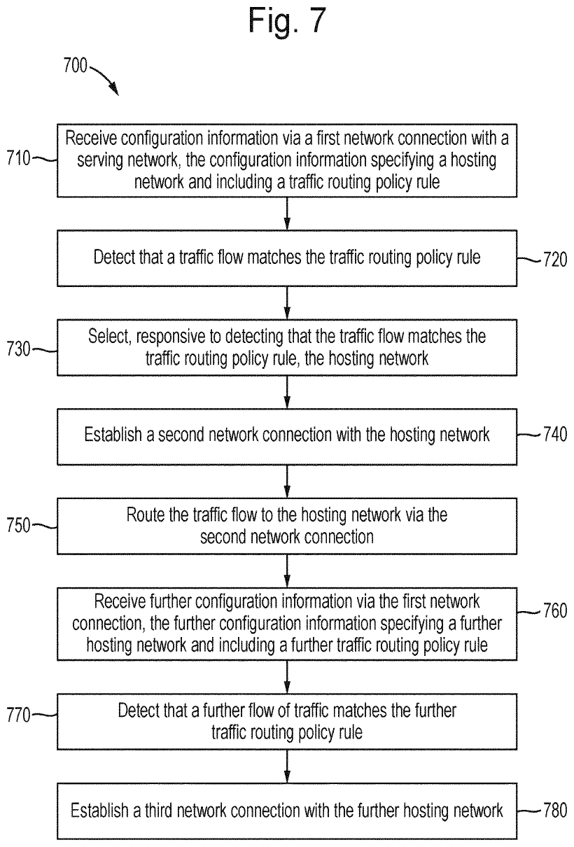

FIG. 7 is a process flow chart showing certain steps of a method 700 which may be performed by the UE 200 for automatic service-based hosting network discovery and selection, thereby to allow the UE 200 to use the one or more localized services in the HtNW 102. The method 700 for automatic service-based hosting network discovery and selection is performed by the UE 200 to allow, thereafter, the UE 200 to use one or more localized services in the HtNW 102.

At step s710, the UE 200 receives, via a first network connection with the serving network (i.e., in this embodiment, the home network home NW 104), configuration information, the configuration information specifying the hosting network (i.e. in this embodiment, HtNW 102) and including a traffic routing policy rule comprising a traffic descriptor for identifying traffic of the localized service to be routed via the hosting network. In this embodiment, the traffic routing policy rule is in accordance with the first URSP 500 described above with reference to FIG. 5. The traffic descriptor is in accordance with the TD 502 described above with reference to FIG. 5, and may include, for example: one or more Application Descriptors (e.g., OSID/OSAppID); one or more IP flow descriptors (e.g., target address of application traffic); one or more DNNs requested by the App 107; or one or more connection capabilities requested by the App 107 (e.g. an IMS connection). In this embodiment, the traffic routing policy rule further comprises one or more RSDs, in accordance with the one or more RSDs (e.g. the first RSD 504) described above.

At step s720, the UE 200 detects that a traffic flow matches the traffic routing policy rule. In this embodiment, the traffic flow is traffic of the one or more localized services of the App 107 which is to be routed via the HtNW 102.

At step s730, the UE 200 selects, responsive to detecting that the traffic flow matches the traffic routing policy rule, the HtNW 102. In this embodiment, the selecting, responsive to detecting that the traffic flow matches the traffic routing policy rule, the HtNW 102 is done in accordance with the automatic network selection procedure 480 described above.

In this embodiment, step s730 may comprise: conducting a scan to determine one or more available networks; and selecting the HtNW 102 from the one or more available networks.

At step s740, the UE 200 establishes a second network connection with the HtNW 102. In this embodiment, the establishing the second network connection with the hosting network is done in accordance with the registration procedure 490 and the establishment 495 of the PDU session in the HtNW described above.

At step s750, the UE 200 routes the traffic flow, i.e. the traffic of the one or more localized services of the App 107, to the HtNW 102 via the second network connection.

In this embodiment, the one or more RSDs may include at least one of: one or more session and service continuity mode selections, one or more network slice selections, one or more data network name selections, one or more protocol data unit session type selections, one or more non-seamless offload indications, or one or more access type preferences.

In this embodiment, a first RSD of the one or more RSDs is in accordance with the first RSD 504 described above. Specifically, the first RSD comprises a hosting network offload component, the hosting network offload component being settable between a plurality of states, a first state of the plurality of states indicating that offload via the hosting network should be performed, and a second state of the plurality of states indicating that offload via the hosting network should not be performed.

In this embodiment, the step s730 may comprise, responsive to the network offload component being in the first state, initiating an automatic network selection procedure in accordance with the automatic network selection procedure 480 described above.

In this embodiment, the step s730 may comprise, responsive to the network offload component being in the second state, initiating a transfer of the UE 200 to the idle state and/or requesting release of the UE 200 from the first connection with the HPLM 104.

In this embodiment, the configuration information may further comprise: a list of one or more preferred hosting networks, one or more selection criteria associated with one or more preferred hosting networks, one or more availability conditions associated with one or more preferred networks, statement of requirements information associated with the localized service, one or more service IDs associated with the localized service, a list of one or more preferred hosting networks and, for each network of the one or more preferred hosting networks, one or more respective associated localized services, or one or more application IDs associated with an application that uses the localized service.

The configuration information may further still comprise: one or more selection criteria associated with one or more preferred hosting networks, the one or more selection criteria including at least one of: an indication of an application (e.g. the App 107) which is associated with the UE 200 and uses the one or more localized services; a time duration during which the HtNW 102 may be selected; or a location of the UE 200 at which the HtNW 102 may be selected. The one or more selection criteria are in accordance with the one or more selection criteria described in embodiments above.

In this embodiment, the traffic routing policy rule may comprise an identifier of the HtNW 102, wherein the identifier is in accordance with the one or more hosting networks IDs described in embodiments above.

In this embodiment, the home NW 104 is a network to which the UE 200 has subscribed, and the home NW 104 stores a Subscription Permanent Identifier (SUPI) and one or more credentials of the UE 200.

In this embodiment, the traffic descriptor may include at least one of: one or more application descriptors; one or more Internet Protocol, IP, flow descriptors; one or more target addresses of application traffic; one or more data network names requested by an application (e.g. the App 107); or one or more connection capabilities requested by an application (e.g. the App 107).

In some embodiments, the method 700 may optionally comprise, at step s760, receiving, via the first network connection with the home network, further configuration information, wherein the further configuration information specifies a further hosting network and includes a further traffic routing policy rule comprising a further traffic descriptor for identifying traffic of a further localized service to be routed via the further hosting network.

The method 700 may further optionally comprise, at step s770, detecting that a further traffic flow matches the further traffic routing policy rule.

The method 700 may further still optionally comprise, at step s780, responsive to detecting that the further traffic flow matches the further traffic routing policy rule, establishing a third network connection with the further hosting network.

Thus, a method 700 for allowing the UE 200 to use the one or more localized services in the HtNW 102 is provided.

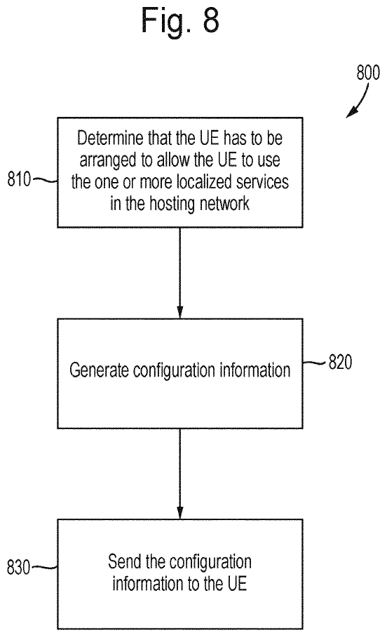

FIG. 8 is a process flow chart showing certain steps of a method 800 performed by one or more network nodes of the home NW 104 of the UE 200. Method 800 is performed by the one or more network nodes of the home NW 104 of the UE 200 for configuring the UE 200 for automatic service-based hosting network discovery and selection.

At step s810, the one or more network nodes determine that the UE 200 has to be arranged to allow the UE 200 to use the one or more localized services in the HtNW 102.

At step s820, the UE 200 generates configuration information, the configuration information specifying the HtNW 102 and including a traffic routing policy rule comprising a traffic descriptor for identifying traffic of the one or more localized services to be routed via the HtNW 102. In this embodiment, the traffic routing policy rule is in accordance with the first URSP 500 described above with reference to FIG. 5. The traffic descriptor is in accordance with the TD 502 described above with reference to FIG. 5.

At step s830, the UE 200 sends the generated configuration information to the UE 200.

The method 800 may further comprise receiving, from the AF, an identifier for the HtNW 102 and/or one or more availability conditions associated with the HtNW 102. The first UDM 400 of the home NW 104 may receive this information from the AF via the NEF 424. The generating the configuration information may include using the received identifier for the hosting network and/or the one or more availability conditions associated with the hosting network.

Thus, a method 800 for configuring, by one or more network nodes of the home NW 104 of the UE 200, the UE 200 to allow the UE 200 to use the one or more localized services in the HtNW 102 is provided.

In an embodiment, one or more network nodes arranged to execute the method 800 are provided. Specifically, the one or more network nodes comprise: one or more processors arranged to: determine that the UE 200 has to be arranged to allow the UE 200 to use the one or more localized services in the HtNW 102; and generate the configuration information specifying the HtNW 102 and including the traffic routing policy rule comprising the traffic descriptor for identifying traffic of the one or more localized services to be routed via the HtNW 102; and a transmitter arranged to send the generated configuration information to the UE 200.

The one or more network nodes may comprise a PCF arranged to trigger a UE policy update procedure to send the generated configuration information to the UE 200. In this embodiment, the PCF is in accordance with the H-PCF 442 described in embodiments above.

The one or more network nodes may also comprise a UDM system arranged to use a UE parameter update procedure or SoR procedure to provision a list of preferred hosting networks. In this embodiment, the UDM system is in accordance with the UDM system 400 described in embodiments above.

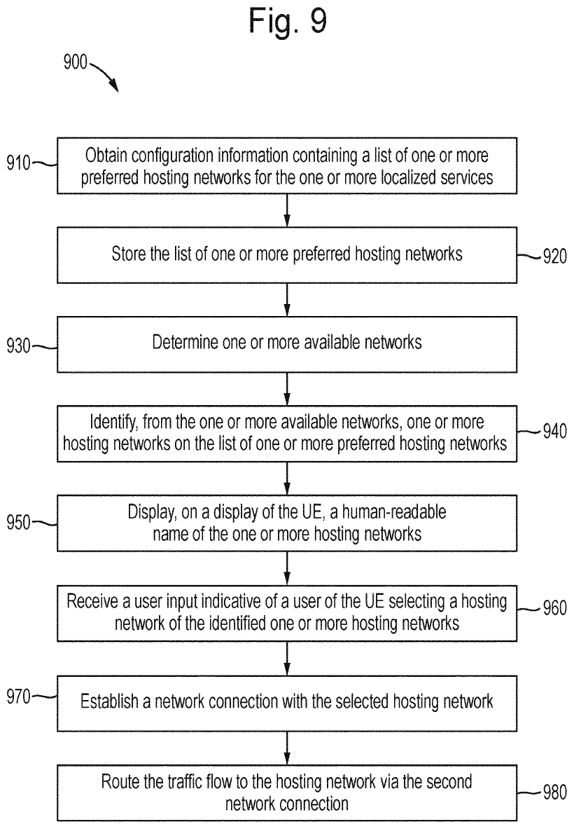

FIG. 9 is a process flow chart showing certain steps of a further method 900 which may be performed by the UE 200, thereby to allow the UE 200 to use the one or more localized services in the HtNW 102. The method 900 for manual service-based hosting network discovery and selection is performed by the UE 200 to allow, thereafter, the UE 200 to use the one or more localized services in the HtNW 102.

At step s910, the UE 200 obtains configuration information, the configuration information containing a list of one or more preferred hosting networks for the one or more localized services. In this embodiment, the list of one or more preferred hosting networks is in accordance with the list of preferred hosting networks described in embodiments above. Step s910 may include receiving, from the home NW 104 via a pre-existing network connection, the configuration information. Alternatively, the UE 200 may be pre-configured with the configuration information. Alternatively, step s910 may include receiving, via an application (e.g. the App 107), the configuration information from an application server (e.g. a server of the third-party service provider).

Optionally, at step s920, the UE 200 may store the list of one or more preferred hosting networks.

At step s930, the UE 200 determines one or more available networks. In this embodiment, step s930 may comprise the UE 200 conducting a scan to determine the one or more available (e.g. hosting) networks. Step s930 may be executed in response to receiving an initial user input requesting a scan and identifying an application (e.g. the App 107) that uses the one or more localized services.

At step s940, the UE 200 identifies one or more hosting networks of the one or more available networks as being networks which are on the list of one or more preferred hosting networks.

At step s950, the UE 200 displays, on a display of the UE 200 (e.g. a display of the output device 220 of the UE 200), a human-readable name of the identified one or more hosting networks.

At step s960, the UE 200 receives a user input indicative of a user of the UE 200 selecting the HtNW 102 of the identified one or more hosting networks.

At step s970, the UE 200 establishes a network connection with the selected HtNW 102. The establishing the network connection with the HtNW 102 is executed in accordance with the establishment 495 of the PDU session in the HtNW 102 described above.

In this embodiment, the steps s910-s960 are in accordance with the manual network selection procedure 470 described above.

At step s970, the UE 200 routes the traffic flow, i.e. the traffic of the one or more localized services of the App 107, to the HtNW 102 via the second network connection.

In this embodiment, the list of one or more preferred hosting networks for the one or more localized services may include: one or more selection criteria; and one or more hosting network IDs. Each of the one or more selection criteria are associated with a respective one of the one or more hosting network IDs. The one or more selection criteria are in accordance with the one or more selection criteria described in embodiments above. The one or more hosting network IDs are in accordance with the one or more hosting network IDs described in embodiments above. The one or more selection criteria may include at least one of: an indication of an application which is associated with the UE 200 and uses the localized service; a time duration during which the hosting network may be selected; or a location of the UE 200 at which the hosting network may be selected.

In this embodiment, step s950 may include, responsive to the identifying one or more hosting networks of the one or more available hosting networks as being networks which are on the list of one or more preferred hosting networks, filtering the one or more available hosting networks, thereby to produce a filtered list of one or more networks comprising only those networks of the one or more available networks which are also in the list of one or more preferred hosting networks. Step s950 may also include displaying the human-readable name of the filtered list of one or more networks on the display of the UE 200.

In some embodiments, the method 900 may optionally comprise obtaining further configuration information, the further configuration information containing a list of a further one or more preferred hosting networks for the localized service.

In some embodiments, the method 900 may further optionally comprise storing the list of a further one or more preferred hosting networks (e.g. in the memory 210 of the UE 200).

In some embodiments, the method 900 may further optionally comprise conducting a scan to determine a further one or more available hosting networks.

In some embodiments, the method 900 may further optionally comprise identifying a further one or more hosting networks of the further one or more available hosting networks as being networks which are on the list of one or more further preferred hosting networks.

In some embodiments, the method 900 may further optionally comprise displaying, on the display of the UE 200, a human-readable name of the identified further one or more hosting networks.

In some embodiments, the method 900 may further optionally comprise receiving a user input indicative of a user of the UE 200 selecting a further hosting network of the identified further one or more hosting networks.

In some embodiments, the method 900 may further optionally comprise establishing a further network connection with the selected further hosting network.

In this embodiment, the configuration information may be based on an Operator controlled PLMN/SNPN selector with Access Technology list, as described in embodiments above.

In this embodiment, the configuration information may include SoR information.

In this embodiment, the configuration information may include availability conditions comprising at least one of: a validity time period and a location.

In this embodiment, the configuration information may include information as to how each of the one or more identified hosting networks maps to the human-readable name of the respective one or more identified hosting networks.

Thus, a further method 900 for allowing the UE 200 to use the one or more localized services in the HtNW 102 is provided.

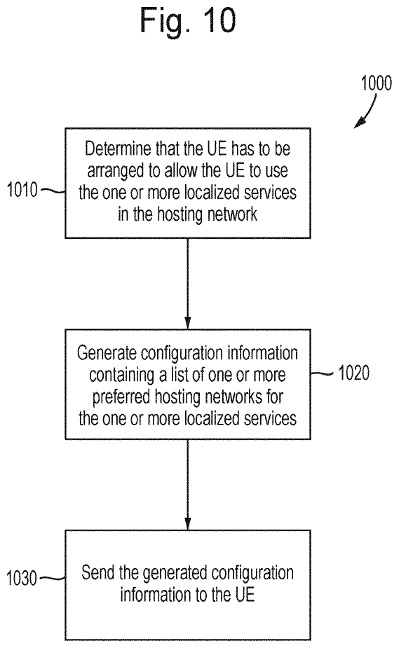

FIG. 10 is a process flow chart showing certain steps of a further method 1000 performed by one or more network nodes of the home NW 104 of the UE 200.

At step s1010, the one or more network nodes determine that the UE 200 has to be arranged to allow the UE 200 to use the one or more localized services in the HtNW 102.

At step s1020, the one or more network nodes generate configuration information, the configuration information containing a list of one or more preferred hosting networks for the one or more localized services. In this embodiment, the list of one or more preferred hosting networks is in accordance with the list of preferred hosting networks described in embodiments above.

At step s1030, the one or more network nodes send the generated configuration information to the UE 200.

The method of FIG. 10 may further comprise receiving, from the AF, an identifier for the HtNW 102 and/or one or more availability conditions associated with the HtNW 102. The first UDM 400 of the home NW 104 may receive this information from the AF via the NEF 424. The generating the configuration information may include using the received identifier for the hosting network and/or the one or more availability conditions associated with the hosting network.

In an embodiment, one or more network nodes arranged to execute the method 1000 are provided. Specifically, the one or more network nodes comprise one or more processors arranged to determine that the UE 200 has to be arranged to allow the UE 200 to use the one or more localized services in the HtNW 102 and to generate configuration information, the configuration information containing a list of one or more preferred hosting networks for the one or more localized services. The one or more network nodes further comprise a transmitter arranged to send the generated configuration information to the UE 200.

The one or more network nodes may comprise a PCF arranged to trigger a UE policy update procedure to send the generated configuration information to the UE 200. In this embodiment, the PCF is in accordance with the H-PCF 442 described in embodiments above.

The one or more network nodes may also comprise a UDM system arranged to use a UE parameter update procedure or SoR procedure to provision a list of preferred hosting networks. In this embodiment, the UDM system is in accordance with the UDM system 400 described in embodiments above.

Advantageously, the embodiments described herein provide the ability to a UE to receive, store and process a new URSP's RSD component (e.g. a “Hosting NW offload” or “Serving Network Preference”) to trigger network reselection and registration.

Advantageously, the embodiments described herein allow the H-PCF of the home network to generate a URSP rule containing a new RSD component (e.g. a “Hosting NW offload” or “Serving Network Preference”) to trigger network reselection and registration.

Advantageously, the embodiments described herein provide the ability to a UE to receive, store and process “information for hosting network selection” (a list of preferred networks with access type), while some entries (or network IDs) may be associated with validity criteria (e.g. time span, location) to be considered.

Advantageously, in the manual network selection procedure, the UE is provided additional matching of each hosting network ID with a corresponding human-readable name, thereby to allow display of human-readable network names to the user for selection.

Advantageously, network selection by the UE according to the embodiments described herein allows network selection which considers the specific localized service which the user of the UE wishes to access.

Advantageously, the embodiments described herein provide for improved mobility and session continuity for use of a localized service via a hosting network.

Advantageously, the embodiments described herein tend to allow for use of a localized service by a user of the UE while roaming.

Advantageously, the embodiments described herein allow for both manual and automatic hosting network selection by the UE, thereby to access a localized service.

Advantageously, the embodiments described herein provide for filtering of available networks according to the information for hosting network selection prior to their display to a user of the UE, thereby to present to the user for manual network selection only those hosting networks which are suitable for accessing the localized service of interest.

Advantageously, the embodiments described herein provide for hosting network selection by the UE from both an idle and a connected state.

Advantageously, the embodiments described herein allow configuration information to be obtained by the UE in multiple ways, thereby to allow configuration of the UE for hosting network selection in a variety of scenarios.

Advantageously, the one or more localized services provided via the hosting network may offer a better user experience compared to those provided via an Internet connection alone. In this embodiment, the one or more localized services provided via the hosting network may be established as needed (on a short-term basis) without the need for, e.g., long-term business relationships, permanently installed equipment, etc., between the third-party service platform and the rest of the network architecture.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method performed by a user equipment (UE), the method comprising:
obtaining configuration information, the configuration information containing a list of one or more preferred hosting networks for a localized service;
determining one or more available networks;
from the determined one or more available networks, identifying one or more hosting networks on the list of the one or more preferred hosting networks;
selecting a hosting network of the identified one or more hosting networks; and
establishing a network connection with the selected hosting network.

2-20. (canceled)

21. At least one network node of a home network of a user equipment (UE), the at least one network node comprising:
one or more processors arranged to:
determine that the UE has to be arranged to allow the UE to use a localized service in a hosting network; and
generate configuration information, the configuration information containing a list of one or more preferred hosting networks for the localized service; and
a transmitter arranged to send the generated configuration information to the UE.

22-23. (canceled)

24. A user equipment (UE) for wireless communication, comprising:
at least one memory; and
at least one processor coupled with the at least one memory and configured to cause the UE to:
obtain configuration information comprising a list of one or more preferred hosting networks for a localized service;
determine one or more available networks;
identify one or more hosting networks of the one or more available networks that are on the list of the one or more preferred hosting networks;
select a hosting network from the identified one or more hosting networks; and
establish a network connection with the selected hosting network.

25. The UE of claim 24, wherein the at least one processor is configured to cause the UE to route localized service data traffic to the selected hosting network via a second network connection.

26. The UE of claim 24, wherein the at least one processor is configured to cause the UE to determine the one or more available networks based at least in part on an initial scan, and identifying an application that uses the localized service.

27. The UE of claim 24, wherein the list of the one or more preferred hosting networks for the localized service includes one or more selection criteria and one or more hosting network identifiers (IDs), and wherein each of the one or more selection criteria is associated with a respective one of the one or more hosting network IDs.

28. The UE of claim 27, wherein the one or more selection criteria includes at least one of an indication of an application that is associated with the UE and uses the localized service, a time duration during which the hosting network may be selected, or a location of the UE at which the hosting network may be selected.

29. The UE of claim 24, wherein, to obtain the configuration information, the at least one processor is configured to cause the UE to receive, from a home network via a pre-existing network connection, the configuration information.

30. The UE of claim 24, wherein the UE is pre-configured with the configuration information.

31. The UE of claim 24, wherein, to obtain the configuration information, the at least one processor is configured to cause the UE to receive, via an application, the configuration information from an application server.

32. The UE of claim 24, wherein the at least one processor is configured to cause the UE to filter the one or more available networks to generate a filtered list of only one or more networks of the one or more available networks that are also in the list of the one or more preferred hosting networks.

33. The UE of claim 24, wherein the configuration information is based at least in part on an operator controlled public land mobile network (PLMN) or stand-alone non-public network (SNPN) selector with access technology list.

34. The UE of claim 24, wherein the configuration information includes steering of roaming information.

35. The UE of claim 24, wherein the configuration information includes availability conditions comprising at least one of a validity time period or a location.

36. The UE of claim 24, wherein the configuration information includes information as to how each of the one or more identified hosting networks maps to the respective identified one or more hosting networks.

37. A processor for wireless communication, comprising:
at least one controller coupled with at least one memory and configured to cause the processor to:
obtain configuration information comprising a list of one or more preferred hosting networks for a localized service;
determine one or more available networks;
identify one or more hosting networks of the one or more available networks that are on the list of the one or more preferred hosting networks;
select a hosting network from the identified one or more hosting networks; and
establish a network connection with the selected hosting network.

38. The processor of claim 37, wherein the at least one controller is configured to cause the processor to route localized service data traffic to the selected hosting network via a second network connection.

39. The processor of claim 37, wherein the at least one controller is configured to cause the processor to determine the one or more available networks based at least in part on an initial scan, and identifying an application that uses the localized service.

40. The processor of claim 37, wherein the list of the one or more preferred hosting networks for the localized service includes one or more selection criteria and one or more hosting network identifiers (IDs), and wherein each of the one or more selection criteria is associated with a respective one of the one or more hosting network IDs.

41. The processor of claim 40, wherein the one or more selection criteria includes at least one of an indication of an application that is associated with the UE and uses the localized service, a time duration during which the hosting network may be selected, or a location at which the hosting network may be selected.
